(19) United States
(12) Patent Application Publication
(10) Pub. No.: US 2016/0098563 A1
(43) Pub. Date: Apr. 7, 2016

(54) SIGNATURES FOR SOFTWARE COMPONENTS

(71) Applicant: SOURCECLEAR, INC., Seattle, WA (US)

(72) Inventor: Asankhaya Sharma, Singapore (SG)

(21) Appl. No.: 14/506,490

(22) Filed: Oct. 3, 2014

(51) Int. Cl. G06F 21/57; G06F 9/44; G06F 17/30

(52) U.S. Cl. CPC G06F 21/577; G06F 17/30097; G06F 17/30106; G06F 8/70; G06F 2221/033

(57) ABSTRACT

A facility for analyzing a pair of code files is described. From each of the code files, the facility extracts a hierarchy of textual names. The facility then determines the score reflecting a level of similarity between the extracted hierarchies of textual names for attribution to the pair of code files.

### TECHNICAL FIELD

The described technology is directed to the field of software development, deployment, and evaluation.

### BACKGROUND

Over the history of software development, software development techniques and technology have advanced significantly, specifically with the use of iterative development (Agile), reusable code (libraries, frameworks and open source), and remote infrastructure (cloud and API services) technologies and methodologies. In addition, the corporate and development culture has also changed, and modern software is now often built by distributed teams that comprise employees (often in different locations), contractors, vendors, and offshore engineers working together.

Thus, both the techniques and approaches used and the development environments being used have changed, with the result that it is not uncommon for the development of a complex software application to be conducted by multiple teams distributed in different locations worldwide, and using software elements (such as libraries, APIs, functional modules, open source code, algorithms, etc.) that are obtained from other sources and not developed in-house by those teams.

### BRIEF DESCRIPTION OF THE DRAWINGS

FIG. 1 is a diagram illustrating elements or components of an example operating environment in which an embodiment of the facility may be implemented.

FIG. 2 is a diagram illustrating additional details of the elements or components of the multi-tenant distributed computing service platform of FIG. 1, in which an embodiment of the facility may be implemented.

FIG. 3 is a diagram illustrating elements or components that may be present in a computer device or system 300 configured to implement a method, process, function, or operation in accordance with an embodiment of the facility.

FIG. 4 is a flow diagram showing steps typically performed by the facility in order to identify components of an application that are vulnerable based upon computer bytecode fingerprints.

FIG. 5 is a data flow diagram illustrating the generation of vulnerable component CBFs for a number of components known to be vulnerable.

FIG. 6 is a flow diagram showing steps typically performed by the facility in order generate a CBF for a single bytecode file.

FIG. 7 is a data flow diagram showing an example of the hierarchy extraction performed by the facility.

FIG. 8 is a data flow diagram showing an example of applying the facility's hashing process.

FIG. 9 is a data flow diagram illustrating the process of comparing application component CBFs to vulnerable component CBFs.

### DETAILED DESCRIPTION

The use of software elements from disparate sources in developing an application can create a risk in that these software elements may contain a virus, an intentionally placed piece of malware, or another form of potentially damaging code that is, as a result, incorporated into the application. Even in the absence of a specifically-known risk, a software element may possess a known vulnerability, so that its use creates a source of risk to a software application or to the development environment. And while much has changed in the area of software development methods, relatively little has changed in the area of software security with regards to the way that security is taken into account when developing applications that incorporate software elements developed by other parties. In this regard, developers typically focus on conducting a testing cycle after software is complete. This is expensive and ineffective, and as recognized by the inventors, may cause the development environment to be exposed to harmful or improperly tested software elements prior to testing of the constructed software. This both creates an inherent risk and is inefficient since the same potentially damaging software element may be incorporated into multiple places in the final software product.

The number of software development languages, frameworks, libraries and APIs available to be used by today's developers has become quite large, and the number of available software elements that may be incorporated into a software application continues to grow. As a result, in order to be aware of potential risks, software developers need to be able to understand and/or track a vast amount of security data related to the code, libraries, and other software elements that they may use in developing an application. Yet application development security teams are rarely able to keep up with the ever increasing volume of software elements, security data, and related information.

One aspect of preventing the introduction of potentially harmful software elements into a development environment is being able to identify whether an element that is being considered for use (or is being developed) has a known vulnerability or is instead expected to be safe. In the case of software components that are in bytecode form, this assessment must be done with respect to the bytecode contents of the software component. As an example, consider Java components that are typically deployed using a jar file. Where a component File.jar is used in an application, the problem is to detect if this component matches any of the components in the catalog of known vulnerable components.

A hardware and/or software facility is described (“the facility”) that generates a fingerprint or other form of identifier for a software element, such as a bytecode software element, that may be used by a developer to construct an application. In some cases, the fingerprint is referred to as a “computer bytecode fingerprint,” or “CBF.” CBF makes use of a uniform format based on bytecode of different platforms like Java, Android, and .NET. CBF contains information about the classes, methods, and fields used in the component; this information is extracted from the bytecode of the component. The fingerprint may then be used to assist in determining if a software element that a developer wishes to introduce into a development environment is known to possess a vulnerability, potentially damaging code, or other form of undesirable aspect. The facility permits the characterization of software elements in a form that permits comparison between such elements to determine whether they are the same or substantially similar, such as to identify suspect elements and preventing their use in a development environment. As a result, the facility can be used to assist a group of developers to reduce the risk to the development process from externally created software elements such as APIs, code, functional modules, open source code, etc. that the developers may wish to incorporate into their software application.

As noted, one purpose of fingerprinting is to allow the comparison or matching of libraries against a larger dataset of known vulnerable libraries (i.e., those known to have a vulnerability or to contain potentially damaging code). When a match occurs, a system/platform that is responsible for managing the access to and integration of software elements into a development environment can alert developers, management, or other appropriate people of a potential risk in using the identified library so that corrective action can be taken (such as by prohibiting use of that library and removing it from consideration for future use).

For the purpose of this description, a “code library” may be one or more of a singular computer file, or other body of code.

In some embodiments, the facility may be used as part of managing the access to and use of software elements in a software development environment used to develop a software application. The facility is used by the system or platform to identify software elements with a known vulnerability and, in response, prevent the incorporation of those elements into an application module being developed within a software development environment. The management function(s) may be implemented as a system or platform which includes processes for generating or deriving a “fingerprint” or “fingerprints” for one or more software elements that a developer desires to use, and compares that fingerprint or fingerprints to a record of the fingerprints of suspect elements (such as a “blacklist” of the fingerprints of elements having a known or suspected vulnerability). Thus, when searching for a “match” the system may perform a many-to-many comparison, with only a single match being required for positive identification of a software element. The fingerprinting process may be provided in any suitable format, independently or as part of a software management platform, and may be implemented by any suitable computing or data processing device (e.g., web-service, cloud-computing service, Software-as-a-Service business model, or as a dedicated server or computing device located in one or more locations, etc.). In one example embodiment, the facility is implemented as part of a multi-tenant cloud-based data processing platform.

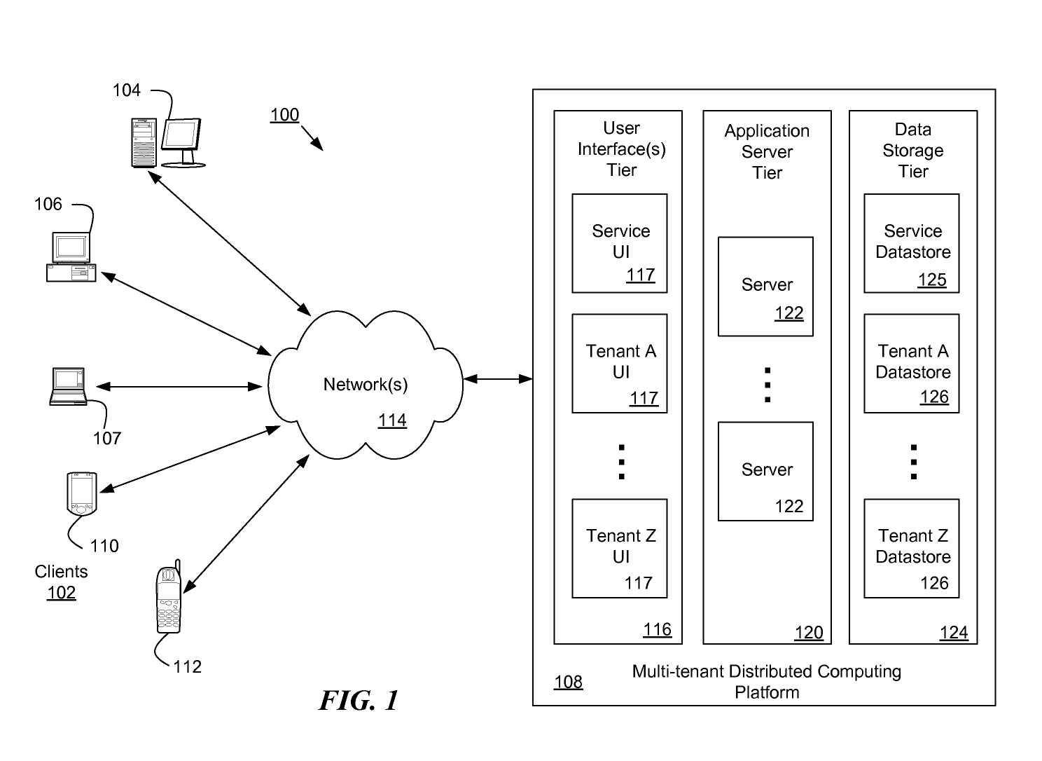

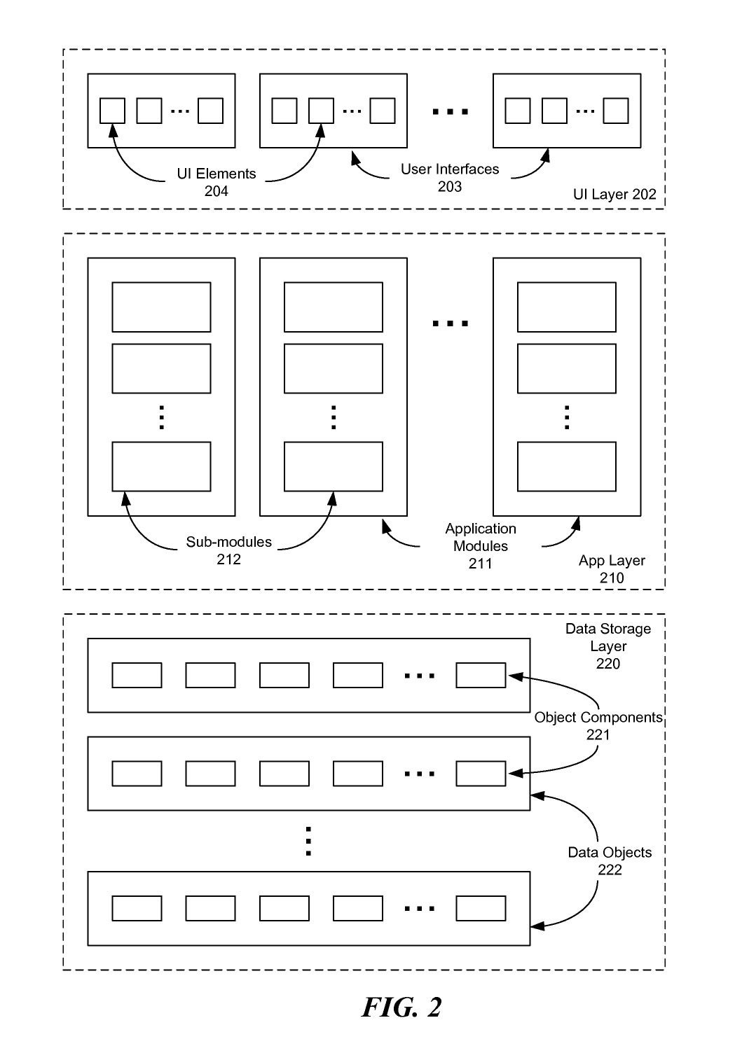

As noted, in some embodiments, the facility is implemented in the context of a multi-tenant, “cloud” based environment (such as a multi-tenant data processing platform), typically used to develop and provide web services for end users. This exemplary implementation environment will be described with reference to FIGS. 1 and 2. Note that the facility may also be implemented in the context of other computing or operational environments or systems, such as for an individual business data processing system, a private network used with a plurality of client terminals, a remote or on-site data processing system, another form of client-server architecture, etc. Note that although FIGS. 1 and 2 are described with reference to use of one or more user interfaces to permit user/tenant interaction with the services provided by the facility, other methods of permitting such interaction may be used instead of or in combination with a user interface. For example, the system/platform may expose one or more APIs (application programming interfaces) to permit a user to interact with the system/platform.

FIG. 1 is a diagram illustrating elements or components of an example operating environment in which an embodiment of the facility may be implemented. In the example operating environment 100, a variety of clients 102 incorporating and/or incorporated into a variety of computing devices may communicate with a distributed computing service/platform 108 through one or more networks 114. In some embodiments, the networks send data via their networking hardware, such as switches, routers, repeaters, electrical cables and optical fibers, light emitters and receivers, radio transmitters and receivers, and the like. For example, a client may incorporate and/or be incorporated into a client application (e.g., software) implemented at least in part by one or more of the computing devices. Examples of suitable computing devices include personal computers, server computers 104, desktop computers 106, laptop computers 107, notebook computers, tablet computers or personal digital assistants (PDAs) 110, smart phones 112, cell phones, and consumer electronic devices incorporating one or more computing device components, such as one or more electronic processors, microprocessors, central processing units (CPUs), or controllers. Examples of suitable networks 114 include networks utilizing wired and/or wireless communication technologies and networks operating in accordance with any suitable networking and/or communication protocol (e.g., the Internet).

The distributed computing service/platform (which may also be referred to as a multi-tenant data processing platform) 108 may include multiple processing tiers, including a user interface tier 116, an application server tier 120, and a data storage tier 124. The user interface tier 116 may maintain multiple user interfaces 117, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user-specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, specifying software elements that a developer desires to have access to, creating and/or implementing a software control policy, initiating a process to fingerprint a software element and compare it to a list of suspect elements, etc. Each processing tier shown in the figure may be implemented with a set of computers and/or computer components including computer servers and processors, and may perform various functions, methods, processes, or operations as determined by the execution of a software application or set of instructions. The data storage tier 124 may include one or more data stores, which may include a service data store 125 and one or more tenant data stores 126.

Each tenant data store 126 may contain tenant-specific data that is used as part of providing a range of tenant-specific services or functions, including but not limited to software module management, software development environment access control, characterization of software elements, storage of utilized software elements, generation and storage of software module usage policies, etc. Data stores may be implemented with any suitable data storage technology, including structured query language (SQL) based relational database management systems (RDBMS).

In accordance with one embodiment of the facility, distributed computing service/platform 108 may be multi-tenant, and service platform 108 may be operated by an entity in order to provide multiple tenants with a set of related software development applications, data storage, and functionality. These applications and functionality may include ones that a software development business uses to manage various aspects of its application development operations. For example, the applications and functionality may include providing web-based access to software development information systems, thereby allowing a user with a browser and an Internet or intranet connection to view, enter, process, or modify certain types of information.

The integrated system shown in FIG. 1 may be hosted on a distributed computing system made up of at least one, but typically multiple, “servers.” A server is a physical computer dedicated to run one or more software services intended to serve the needs of the users of other computers in data communication with the server, for instance via a public network such as the Internet or a private “intranet” network. The server, and the services it provides, may be referred to as the “host,” and the remote computers and the software applications running on the remote computers may be referred to as the “clients.” Depending on the computing service that a server offers it could be referred to as a database server, file server, mail server, print server, web server, etc. A web server is most often a combination of hardware and the software that helps deliver content (typically by hosting a website) to client web browsers that access the web server via the Internet.

FIG. 2 is a diagram illustrating additional details of the elements or components of the multi-tenant distributed computing service platform of FIG. 1, in which an embodiment of the facility may be implemented. The software architecture depicted in FIG. 2 represents an example of a software system to which an embodiment of the facility may be applied. In general, an embodiment of the facility may be implemented by using a set of software instructions that are designed to be executed by a suitably programmed processing element (such as a CPU, microprocessor, processor, controller, computing device, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 2 is a diagram illustrating additional details of the elements or components 200 of the multi-tenant distributed computing service platform of FIG. 1, in which an embodiment of the facility may be implemented. The example architecture includes a user interface layer or tier 202 having one or more user interfaces 203. Examples of such user interfaces include graphical user interfaces and application programming interfaces (APIs). Each user interface may include one or more interface elements 204. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 210 may include one or more application modules 211, each having one or more sub-modules 212. Each application module 211 or sub-module 212 may correspond to a particular function, method, process, or operation that is implemented by the module or sub-module. Such function, method, process, or operation may include those used to implement one or more aspects of the facility, such as for:
Generating an identifier from information regarding a software library or other element using one or more of the methods or processes described herein (where such an identifier may represent a canonical form for the library or element);
Comparing the generated identifier to one or more lists or sources of identifiers for software elements having a known vulnerability or other suspect aspect; or
In response to determining that a software element that a developer desires to utilize has an identifier that matches that of a software element having a known vulnerability or other suspect aspect, generating a notification to one or more of the developer, a manager of the development environment, or other suitable entity.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language or bytecode. Each application server (e.g., as represented by element 122 of FIG. 1) may include each application module. Alternatively, different application servers may include different sets of application modules. Such sets may be disjoint or overlapping.

The data storage layer 220 may include one or more data objects 222 each having one or more data object components 221, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 1-2 are not intended to be limiting examples. Alternatively, or in addition, computing environments in which an embodiment of the facility may be implemented include any suitable system that permits users to provide data to, and access, process, and utilize data stored in a data storage element (e.g., a database) that can be accessed remotely over a network. Further example environments in which an embodiment of the facility may be implemented include devices, software applications, systems, apparatuses, or other configurable components that may be used by multiple users for data entry, data processing, application execution, software development, data review, etc. and which have user interfaces, expose APIs, or present user interface components that can be configured to present an interface to a user. Although further examples below may reference the example computing environment depicted in FIGS. 1-2, it will be apparent to one of skill in the art that the examples may be adapted for alternate computing devices, systems, apparatuses, processes, and environments.

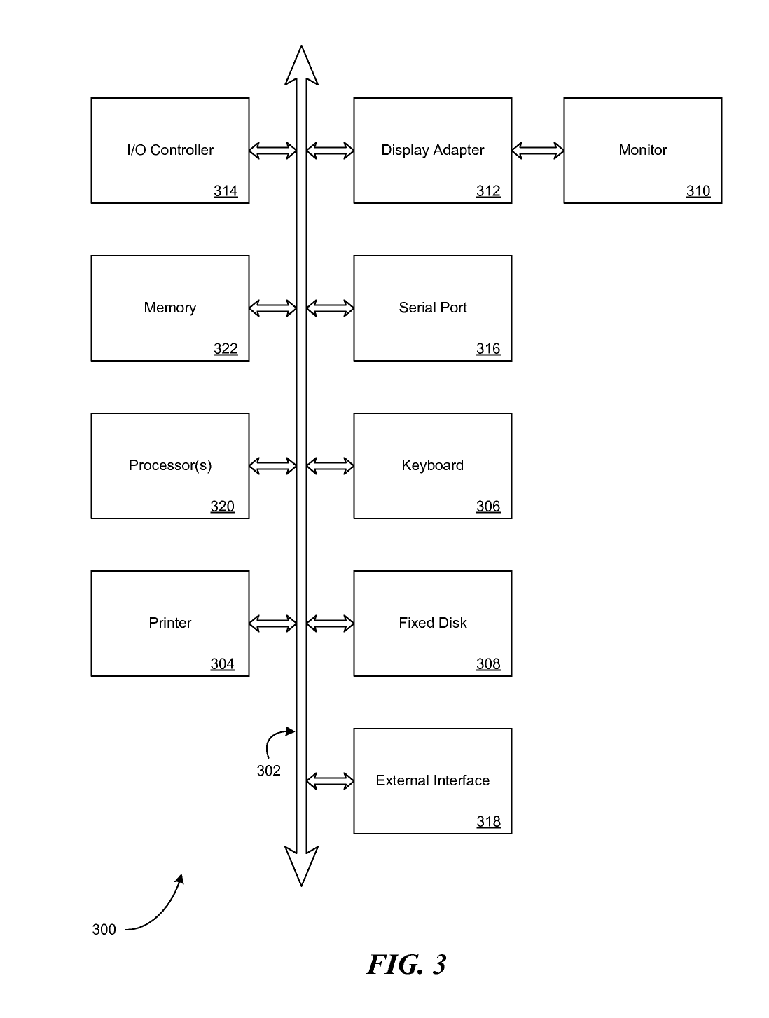

In accordance with one embodiment of the facility, the system, apparatus, methods, processes, functions, and/or operations for generating an identifier for a software element may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system. As an example, FIG. 3 is a diagram illustrating elements or components that may be present in a computer device or system 300 configured to implement a method, process, function, or operation in accordance with an embodiment of the facility. The subsystems shown in FIG. 3 are interconnected via a system bus 302. Additional subsystems include a printer 304, a keyboard 306, a fixed disk 308, and a monitor 310, which is coupled to a display adapter 312. Peripherals and input/output (I/O) devices, which couple to an I/O controller 314, can be connected to the computer system by any number of means known in the art, such as a serial port 316. For example, the serial port 316 or an external interface 318 can be utilized to connect the computer device 300 to further devices and/or systems not shown in FIG. 3 including a wide area network such as the Internet, a mouse input device, and/or a scanner. The interconnection via the system bus 302 allows one or more processors 320 to communicate with each subsystem and to control the execution of instructions that may be stored in a system memory 322 and/or the fixed disk 308, as well as the exchange of information between subsystems. The system memory 322 and/or the fixed disk 308 may embody a tangible computer-readable medium.

It should be understood that the facility as described above can be implemented in the form of control logic using computer software in a modular or integrated manner. Based on the disclosure and teachings provided herein, a person of ordinary skill in the art will know and appreciate other ways and/or methods to implement the facility using hardware and a combination of hardware and software.

Any of the software components, processes or functions described in this application may be implemented as software code to be executed by a processor using any suitable computer language such as, for example, Java, Javascript, C++ or Perl using, for example, procedural, object oriented and functional programming techniques. The software code may be stored as a series of instructions, or commands on a computer readable medium, such as a random access memory (RAM), a read only memory (ROM), a magnetic medium such as a harddrive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

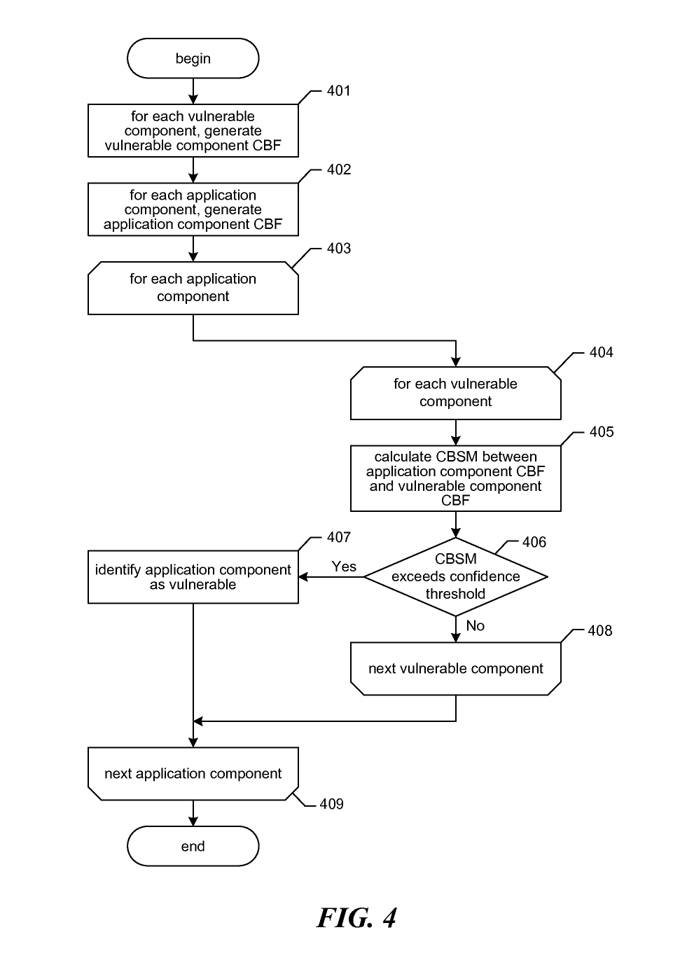

FIG. 4 is a flow diagram showing steps typically performed by the facility in order to identify components of an application that are vulnerable based upon computer bytecode fingerprints. In step 401, for each component already determined to be vulnerable, the facility generates a vulnerable component CBF.

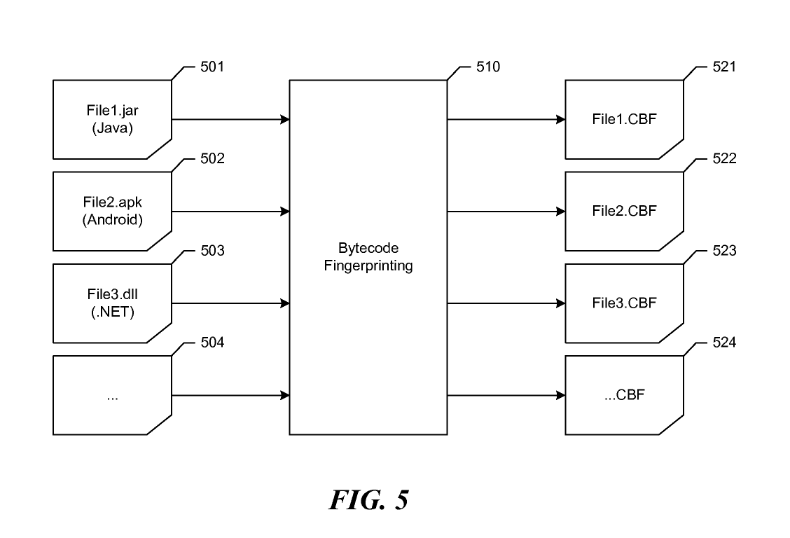

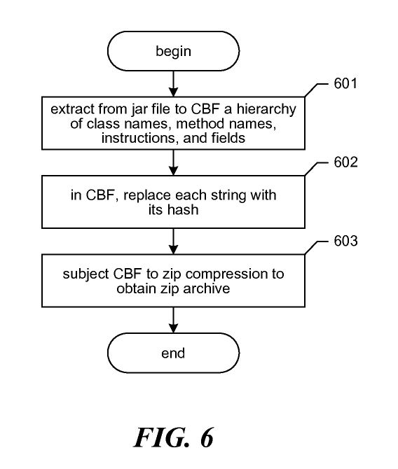

FIG. 5 is a data flow diagram illustrating the generation of vulnerable component CBFs for a number of components known to be vulnerable. Each of a number of vulnerable components, such as vulnerable components 501-504, are subjected to a bytecode fingerprinting process 510, whose details are discussed below in connection with FIG. 6. For each of the components, the bytecode fingerprinting process produces a CBF, here CBFs 521-524. The bytecode components can be in a number of different forms, including jar files containing Java bytecodes, DLL files containing .net bytecodes, and APK files containing Android bytecodes, to name a few. In some embodiments, the facility uses the following libraries to read bytecode files of these various types: the OW2 ASM library available from asm.ow2.org for reading Java bytecode (.jar files), Mono.Cecil library www.monoproject.com/Cecil for reading .NET bytecode (All files) and (W2 ASMDEX library asm.ow2.org/asmdex-indes.html for reading Android bytecode (.apk files). More readers can be added to support other bytecode formats as well.

FIG. 6 is a flow diagram showing steps typically performed by the facility in order generate a CBF for a single bytecode file. In step 601, the facility extracts from the bytecode file, such as a jar file, to a CBF a hierarchy of the following: class names, method names, instructions--without their operands or arguments, and fields.

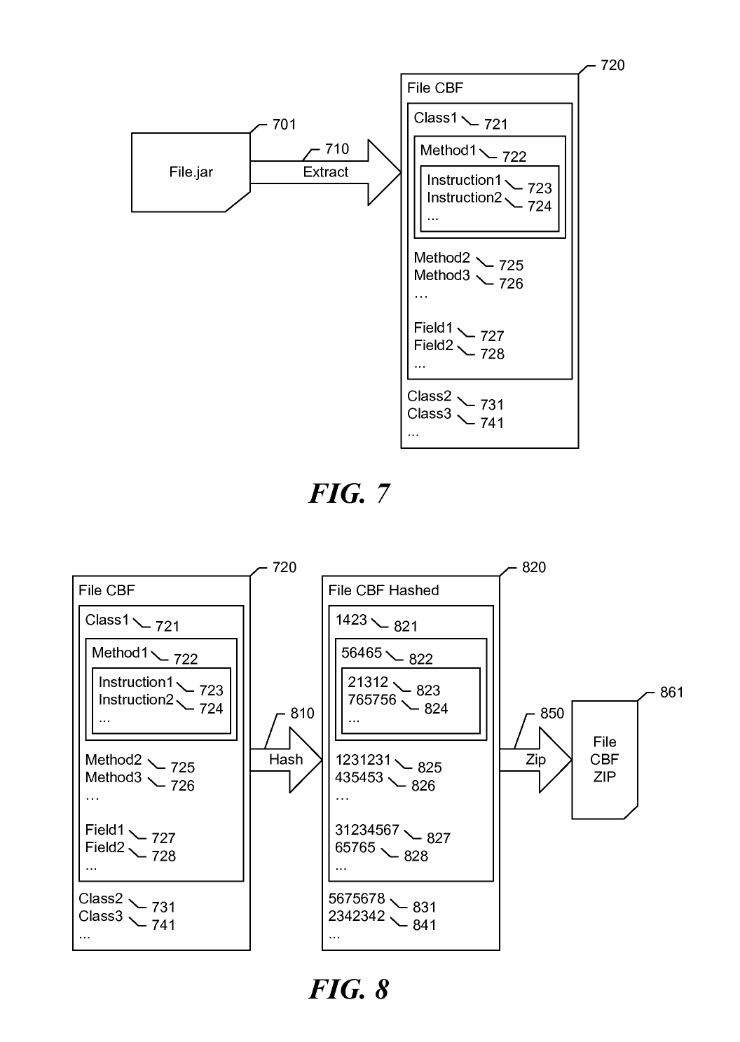

FIG. 7 is a data flow diagram showing an example of the extraction performed in step 601. Here, a bytecode file 701 is the subject of extraction process. The extraction process results in a CBF file 720. In the CBF file, the first level of the hierarchy are three class names: a Class1 class name 721, a Class2 class name 731, and a Class3 class name 741. In the hierarchy under the Class1 class name 721, the following occur: a Method1 method name 722, a Method2 method name 725, a Method3 method name 726, a Field1 field name 727, and a Field2 field name 728. Under the Method1 method name 722 are an Instruction1 instruction name 723, and an Instruction2 instruction name 724.

Returning to FIG. 6, in step 602, in the CBF, the facility replaces each string with its hash. In various embodiments, various in various embodiments, the facility employs a variety of hashing algorithms in performing this replacement.

FIG. 8 is a data flow diagram showing an example of applying the hashing process of step 602. In FIG. 8, the hashing process 810 is applied to the CBF file 720 shown as being generated in FIG. 7. It can be seen in the hashed CBF file 820 resulting from the hashing process that each string has been replaced with a hash value generated for the string by a hashing function. For example, the “Class1” string from the Class1 class name 721 has been transformed to the hash value “1423” shown with reference number 821.

Returning to FIG. 6, in step 603, the facility subjects the CBF in which strings have been replaced with their hash values to a zip compression process to obtain a zip archive. After step 603, these steps conclude.

Those skilled in the art will appreciate that the steps shown in FIG. 6 and in each of the flow diagrams discussed elsewhere herein may be altered in a variety of ways. For example, the order of the steps may be rearranged; some steps may be performed in parallel; shown steps may be omitted, or other steps may be included; a shown step may be divided into substeps, or multiple shown steps may be combined into a single step, etc.

Returning to FIG. 8, it can be seen that the zip compression process 850 is applied to the hashed CBF file 820, to produce a CBF zip archive file 861.

Returning to FIG. 4, in steps 403-409, the facility loops through each component making up the application. In steps 404-408, the facility loops through each vulnerable component. In step 405, the facility compares the current application, component to the current vulnerable component by calculating a Common Bytecode Similarity Metric (“CBSM”) that reflects their level of similarity. In particular, given two CBF files, the CBSM characterizes the similarity between the components as a number between 0 and 1 (1 being exactly the same). The CBSM is a weighted mean of the similarity of classes, methods, and fields in the CBF files. It is calculated as follows.

Let C(file1) be the set of classes in file file1, and C(file2) be the set of classes in file file2, respectively. Comparing files file1.CBF and file2.CBF:

CBSM(file1, file2)=(ΣCBSM_class(c1, c2))/|C(file1)∪C(file2)| (1)

Let M(c1) and M(c2) be the set of methods in class c1 and c2 respectively,

And let F(c1) and F(c2) be the set of fields in class c1 and c2 respectively,

Then, for each class c1==c2 that is present in both file file1 and file file2:

CBSM_class(c1, c2)=(w1*ΣCBSM_method(m1, m2)/|M(c1)∪M(c2)|)+w2*(|F(c1)∩F(c2)|)/(|F(c1)∪F(c2)|) (2)

Where, w1 and w2 are the weights assigned to give importance to matching methods and fields respectively. This is done to take into account the fact that a match based on the entire method is more important than a match between fields. (e.g. w1=0.8 and w2=0.2 says that method match contributes 80% of the total matching while fields contribute only 20%)

Let I(m1) and I(m2) be the set of instructions in method ml and method m2 respectively, ignoring any operands or arguments,

Then,

CBSM_method(m1, m2)=|I(m1)∩I(m2)|/|I(m1)∪I(m2)| (3)

In step 406, if the CBSM calculated in step 405 exceeds a confidence threshold, then the facility continues in step 407, else the facility continues in step 408. In step 407, the facility identifies the application component as vulnerable. In some embodiments, the confidence threshold is user-configurable. In some embodiments, the confidence threshold is 80%. After step 407, the facility continues in step 409. In step 408, if additional vulnerable components remain to be processed, the facility continues in step 404 to process the next vulnerable component, else the facility continues in step 409. In step 409, if additional application components remain to be processed, then the facility continues in step 403 to process the next application component, else these steps conclude.

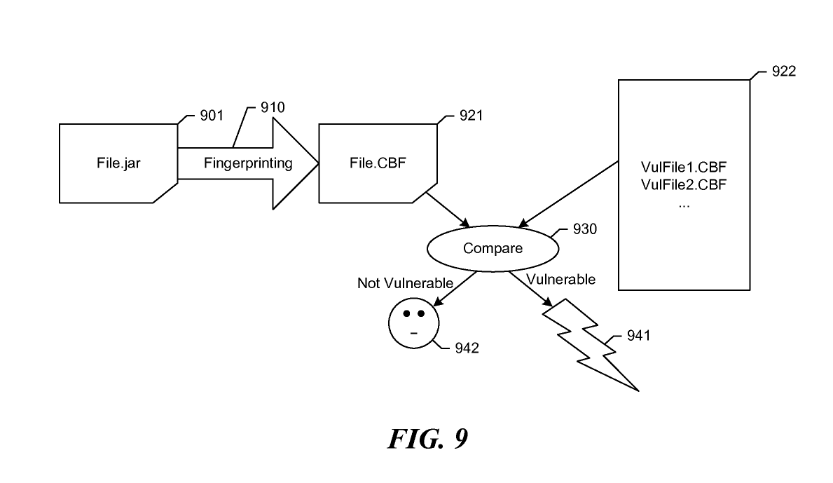

FIG. 9 is a data flow diagram illustrating the process of comparing application component CBFs to vulnerable component CBFs. FIG. 9 shows the facility's fingerprinting 910 of application bytecode file 901 to obtain application CBF 921. It further shows a comparison 930 of the application CBF 921 to each of a number of vulnerable component CBFs 922. As the result of the comparison 930, the facility may find the application bytecode file to be vulnerable 941, or not vulnerable 942.

An example in which a CBSM is calculated for a pair of components follows below:

### Code Example

Consider the following Person Component (Comp1) below in Table 1:

TABLE 1

| | |
|---|---|
| 1 | public class Person { |
| 2 | String firstName; |
| 3 | String lastName; |
| 4 | public Person(String first, String last) { |
| 5 | this.firstName = first; |
| 6 | this.lastName = last; |
| 7 | } |
| 8 | public String getName( ) { |
| 9 | return this.firstName + “ ” + this.lastName; |
| 10 | } |
| 11 | } |

Further consider a second implementation of Person Component (Comp2) below in Table 2:

TABLE 2

| | |
|---|---|
| 1 | public class Person { |
| 2 | String firstName; |
| 3 | String lastName; |
| 4 | String ID; |
| 5 | public Person (String first, String last, String id) { |
| 6 | this.firstName = first; |
| 7 | this.lastName = last; |
| 8 | this.ID = id; |
| 9 | } |
| 10 | public String getName( ) { |
| 11 | return this.firstName + “ ” + this.lastName; |
| 12 | } |
| 13 | public String getID( ) { |
| 14 | return this.ID; |
| 15 | } |
| 16 | } |

Based on Equation (2), the facility calculates the similarity metric between the two components as follows:
Field Similarity=2/3=0.66 (since two field names—firstName and lastName match between the components)
Method Similarity=(0.66+1+0)/3=0.55 (since there are two matching methods—Person and getName and only ⅔^{rd} of the Person method matches up as there is one extra instruction this.ID=id in the second component.)
Class Similarity=(0.55+0.66)/2=0.61 (assigning equal weightage to method and field similarity)

Thus the overall CBSM (Component Bytecode Similarity Metric)=0.61 (as each component has only 1 class here)

While the foregoing has described fingerprints as being generated for code resources received in bytecode form, in various embodiments, the facility generates bytecodes for software resources received in a variety of forms. As one example, in some embodiments, the facility generates fingerprints for code resources received in the source code form.

In some such embodiments, the facility uses a code translator to convert from the form in which a code resource was received into bytecode form, then generates a fingerprint from the bytecode form. Where a code resource is received in source code form, the facility performs this conversion by compiling the code resource in source code form.

In some such embodiments, the facility generates a fingerprint from the code resource in its original form. In the case of a code resource that is received in source code form, the facility generates a fingerprint by extracting a textual hierarchy from the abstract syntax tree of the program. In some embodiments, the facility performs certain kinds of translation between fingerprints generated from code resources in one form for comparison to fingerprints generated from code resources of another form.

In some embodiments, the facility generates and compares fingerprints from software resources that are in a uniform form other than bytecode, such as source code.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A computer-readable medium having contents adapted to cause a computing system to perform a method for determining that a bytecode file contains a vulnerability, the method comprising:
identifying a plurality of first bytecode file each known to contain a vulnerability;
for each of the identified first bytecode files, applying a process to the first bytecode files to extract a representation of a hierarchy of textual names occurring in the first bytecode file;
receiving a second bytecode file;
applying the process to the second bytecode file to extract a representation of a hierarchy of textual names occurring in the first bytecode file;
for each of the identified first bytecode files, determining a metric characterizing the similarity of the hierarchy of textual names extracted from the first bytecode file to the hierarchy of textual names extracted from the second bytecode file;
determining that the determined metric exceeds a similarity threshold value; and
in response to determining that the determined metric exceeds a similarity threshold value, generating an indication that the second bytecode file contains a vulnerability.

2. The computer-readable medium of claim 1 further comprising, before determining the metric, for each of the extracted hierarchies, applying a hashing function to transform each textual name of the hierarchy to a numeric value,
and wherein the determination of the metric comprises matching numeric values in the hierarchy extracted from the first bytecode file to numeric values in the hierarchy extracted from the second bytecode file.

3. The computer-readable medium of claim 1 further comprising receiving user input specifying the similarity threshold value.

4. A method in a computing system for analyzing a pair of code files, comprising:
from each of the code files, extracting a hierarchy of textual names; and
determining a score reflecting a level of similarity between the extracted hierarchies of textual names.

5. The method of claim 4 wherein each of the pair of code files is a bytecode file.

6. The method of claim 4 wherein each of the pair of code files is a source code file.

7. The method of claim 4 wherein a first one of the pair of code files is a source code file, and a second code file of the pair of code files is a bytecode file.

8. The method of claim 7, further comprising transforming the source code file into a bytecode file before performing the extracting.

9. The method of claim 4, further comprising:
accessing an indication that a first one of the pair of code files contains a security vulnerability;
determining that the determined score exceeds a minimum similarity threshold; and
based upon the accessing and the determination that the determined score exceeds a minimum similarity threshold, generating an indication that the one of the pair of code files that is not the first one of the pair of code files contains a security vulnerability.

10. The method of claim 4, wherein the comparing comprises:
applying the same hashing function to each of the textual names to obtain a hash value for each; and
comparing the obtained hash values.

11. The method of claim 4 wherein the score is determined based upon a plurality of class subscores each determined for a different class that is defined in both of the code files.

12. The method of claim 11 wherein the class subscore for each class defined in both of the code files is determined at least in part based on the percentage of fields that are in the class definition of both of the code files.

13. The method of claim 11 wherein the class subscore for each class defined in both of the code files is determined at least in part based on the percentage of methods that are in the class definition of both of the code files.

14. The method of claim 11 wherein the class subscore for each class defined in both of the code files is determined at least in part based on the similarity of methods that are in the class definition of both of the code files.

15. The method of claim 11 wherein the class subscore for each class defined in both of the code files is determined at least in part based on the percentage of instructions that are in the class definition of both of the code files.

16. The method of claim 11 wherein the class subscore for each class defined in both of the code files is determined at least in part based on a method subscore for each method that is in the class definition of both of the code files,
and wherein the method subscore for each method that is in the class definition of both of the code files is determined at least in part on the percentage of instructions that are in the method of both of the code files.

17. One or more computer memories collectively storing a computer bytecode fingerprint data structure for a first bytecode resource, the data structure comprising:
a hierarchy of nodes arranged in at least two levels, in which each node (1) corresponds to a textual element of the first bytecode resource, (2) has a position in the hierarchy of nodes corresponding to a hierarchical position of the textual element in the first bytecode resource, and (3) has content that reflects text of the textual element,
such that the contents of the data structure can be compared to the contents of a similar data structure for a second bytecode resource in order to assess the similarity of the first and second bytecode resources.

18. The of claim 17 wherein the content of each node that reflects text of the textual element of the first bytecode resource to which it corresponds is a copy of the reflected text.

19. The of claim 17 wherein the content of each node that reflects text of the textual element of the first bytecode resource to which it corresponds is value produced by hashing the reflected text.
